(19) United States
(12) Patent Application Publication
(10) Pub. No.: US 2024/0220838 A1
(43) Pub. Date: Jul. 4, 2024

(54) COMBINATION OPTIMIZATION CALCULATION METHOD AND COMBINATION OPTIMIZATION CALCULATION SYSTEM

(71) Applicant: PANASONIC INTELLECTUAL PROPERTY MANAGEMENT CO., LTD., Osaka (JP)

(72) Inventors: Koichiro YAMAGUCHI, Osaka (JP); Takahiro OHYAMA, Miyagi (JP); Eiichi ABE, Miyagi (JP)

(73) Assignee: PANASONIC INTELLECTUAL PROPERTY MANAGEMENT CO., LTD., Osaka (JP)

(21) Appl. No.: 18/605,138

(22) Filed: Mar. 14, 2024

Related U.S. Application Data
(63) Continuation of application No. PCT/JP2022/028543, filed on Jul. 22, 2022.

(30) Foreign Application Priority Data
Sep. 15, 2021 (JP) 2021-150621

(51) Int. Cl. G06N 10/20; G06F 17/11

(52) U.S. Cl. CPC G06N 10/20; G06F 17/11

(57) ABSTRACT

A method for calculating combination optimization using a quantum computer configured to execute quantum calculation by a quantum circuit having a parameter representing a phase rotation amount, and a classical computer that calculates a feedback amount based on an output of the quantum computer and newly adds, to the quantum computer, the quantum circuit having the calculated feedback amount as the parameter includes: multiplying, in the classical computer, the feedback amount by a gain having a positive value such that a magnitude of the gain approaches zero as the quantum circuit is added.

### CROSS-REFERENCE TO RELATED APPLICATIONS

This is a continuation of International Application No. PCT/JP2022/028543 filed on Jul. 22, 2022, and claims priority from Japanese Patent Application No. 2021-150621 filed on Sep. 15, 2021, the entire contents of which are incorporated herein by reference.

### TECHNICAL FIELD

The present disclosure relates to a combination optimization calculation method and a combination optimization calculation system.

### BACKGROUND ART

Quantum approximate optimization algorithm (QAOA) is known as an algorithm for solving a combination optimization problem using a quantum computer according to a quantum gate method (for example, see Non Patent Literature 1). QAOA approximately calculates the state in which the energy of a cost function is minimized by searching for the optimal parameter of a quantum circuit using a classical computer.

In QAOA, parameter search processing executed by a classical computer is a bottleneck, and feedback-based algorithm for quantum optimization (FALQON) is known as an algorithm that eliminates this processing (for example, see Non Patent Literature 2).

FALQON sequentially determines parameters of the quantum circuit according to Lyapunov stability in classical control technology. More specifically, the output result of the previous stage quantum circuit is fed back to the quantum circuits connected in multiple stages, and parameters in the next stage quantum circuit are sequentially determined based on the output result.

### CITATION LIST

### Non-Patent Literature

Non Patent Literature 1: Farhi, Edward, Jeffrey Goldstone, and Sam Gutmann. “A quantum approximate optimization algorithm.” arXiv preprint arXiv: 1411.4028 (2014).
Non Patent Literature 2: Magann, Alicia B., et al. “Feedback-based quantum optimization.” arXiv preprint arXiv: 2103.08619 (2021).

### SUMMARY OF INVENTION

In the case of solving the combination optimization problem using FALQON, a feedback amount for determining the parameters of the quantum circuit may not converge, and an executable solution may not be obtained.

An object of the present disclosure is to obtain an executable solution even for a problem that no executable solution can be obtained using FALQON.

The present disclosure provides a combination optimization calculation method for calculating combination optimization using a quantum computer and a classical computer. The quantum computer is configured to execute quantum calculation by a quantum circuit having a parameter representing a phase rotation amount, and the classical computer is configured to calculate a feedback amount based on an output of the quantum computer and to newly add, to the quantum computer, the quantum circuit having the calculated feedback amount as the parameter. The combination optimization calculation method includes multiplying, in the classical computer, the feedback amount by a gain having a positive value such that a magnitude of the gain approaches zero as the quantum circuit is added.

The present disclosure provides a combination optimization calculation system including a quantum computer configured to execute quantum calculation by a quantum circuit having a parameter representing a phase rotation amount, and a classical computer configured to calculate a feedback amount based on an output of the quantum computer and to newly add, to the quantum computer, the quantum circuit having the calculated feedback amount as the parameter. The classical computer multiplies the feedback amount by a gain having a positive value such that a magnitude of the gain approaches zero as the quantum circuit is added.

According to the present disclosure, an executable solution can be obtained even for a problem that an executable solution cannot be obtained using FALQON.

### BRIEF DESCRIPTION OF DRAWINGS

FIG. 1 is a circuit block diagram of FALQON;

FIG. 2 is a block diagram showing a configuration example of a combination optimization calculation system that controls a parameter of a quantum circuit according to a FALQON algorithm;

FIG. 3 is a flowchart showing an operation example of the combination optimization calculation system that controls the parameter of the quantum circuit according to the FALQON algorithm;

FIG. 4 shows a simulation condition when evaluating a traveling salesman problem;

FIG. 5 is a graph showing a result of an expected energy value in each stage of the quantum circuit when solving the traveling salesman problem in four cities;

FIG. 6 is a graph showing a result of a feedback amount β in each stage of the quantum circuit when solving the traveling salesman problem in four cities;

FIGS. 7A and 7B are diagrams showing an executable solution of the traveling salesman problem in four cities;

FIG. 8 is a graph showing an example of the weight of a quantum fluctuation term according to the present embodiment;

FIG. 9 is a graph showing the result of the expected energy value in each stage of the quantum circuit when solving the traveling salesman problem in four cities using the quantum fluctuation weight according to the present embodiment;

FIG. 10 is a graph showing the result of the feedback amount in each stage of the quantum circuit when solving the traveling salesman problem in four cities using the quantum fluctuation weight according to the present embodiment;

FIG. 11 is a block diagram showing a configuration example of a combination optimization calculation system according to the present embodiment to which a feedback gain control method is applied;

FIG. 12 is a flowchart showing an operation example of the combination optimization calculation system that controls the parameter of the quantum circuit by a classical computer according to the present embodiment; and

FIG. 13 is a block diagram showing a hardware configuration example of a classical computer according to the present disclosure.

### DESCRIPTION OF EMBODIMENTS

Hereinafter, an embodiment of the present disclosure will be described in detail with reference to the drawings as appropriate. However, the unnecessarily detailed description may be omitted. For example, the detailed description of already well-known matters and the repeated description of substantially the same configuration may be omitted. This is to avoid the following description from being unnecessarily redundant and to facilitate understanding for those skilled in the art. It should be noted that the accompanying drawings and the following description are provided for those skilled in the art to sufficiently understand the present disclosure, and are not intended to limit the subject matter described in claims.

### Present Embodiment

### <Overview of FALQON>

FALQON is an algorithm for obtaining a feedback amount based on the Lyapunov function used in the classical control theory and sequentially determining a parameter of a quantum circuit that minimizes the energy. Therefore, the search processing for the parameter of the quantum circuit using a classical computer in QAOA becomes unnecessary.

Hereinafter, the theoretical background of FALQON will be described. The time development of FALQON is expressed by the following (Formula 1).

$$i \frac{d}{d t} \vert ψ 〉 = ( {H}_{P} + β ( t ) {H}_{d} ) \vert ψ 〉 \qquad ( Formula 1 )$$

Here, H_{P} represents a target Hamiltonian, that is, an energy function of the problem to be solved. H_{d} is a quantum fluctuation term. β(t) represents a feedback amount. The Lyapunov function in FALQON is expressed by the following (Formula 2).

$$V ( t ) = 〈 ψ ( t ) \vert {H}_{P} \vert ψ ( t ) 〉 \qquad ( Formula 2 )$$

Here, ψ(t) is a quantum state at a time t. According to the Lyapunov stabilization theorem of classical control, when the time differential of V(t) satisfies the following (Formula 3), the quantum state ψ(t) converges at t→∞.

$$\frac{d}{dt} V ( t ) \leq 0 \qquad ( Formula 3 )$$

The feedback amount β(t) satisfying the above is given by the following (Formula 4) and (Formula 5).

$$A ( t ) = 〈 ψ ( t ) \vert i [ {H}_{d} , {H}_{P} ] \vert ψ ( t ) 〉 \qquad ( Formula 4 )$$

$$β ( t ) = - A ( t ) \qquad ( Formula 5 )$$

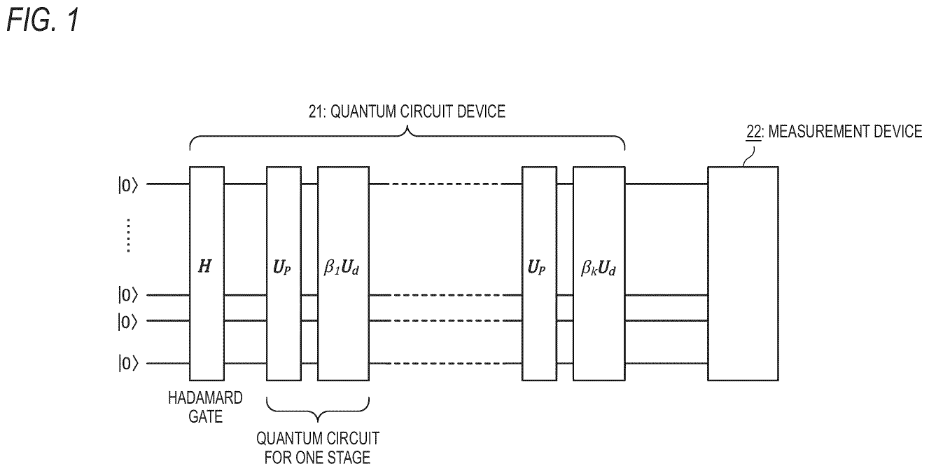

FIG. 1 shows a circuit block diagram of FALQON. When the initial quantum state is |ψ₀>, the quantum state output from the first stage (hereinafter, the stage may be referred to as a layer) quantum circuit using the time development gate of a time step Δt shown in the following (Formula 6) and (Formula 7) is as shown in the following (Formula 8).

$${U}_{P} = exp ( - i Δ {tH}_{P} ) \qquad ( Formula 6 )$$

$${U}_{d} ( β ) = exp ( - i β Δ {tH}_{d} ) \qquad ( Formula 7 )$$

$$\vert {ψ}_{1} 〉 = {U}_{d} ( {β}_{1} ) {U}_{P} \vert {ψ}_{0} 〉 \qquad ( Formula 8 )$$

Assuming that the measured value in (Formula 4) in this state is A₁, the next stage feedback amount β₂ is obtained as β₂=−A₁. The FALQON algorithm repeats this process k times, which is the number of stages of the quantum circuit, and sequentially determines β₁, β₂, . . . , βₖ that provide the ground state of the target Hamiltonian. Note that k represents a layer index.

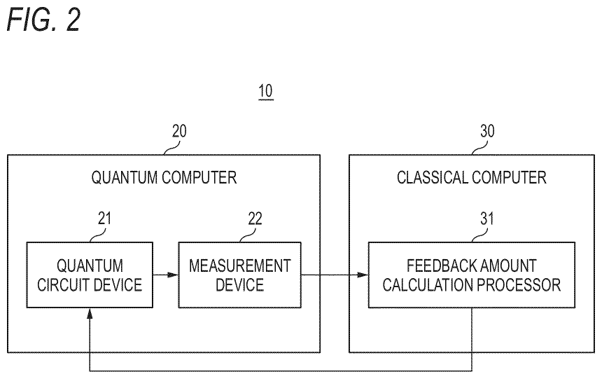

FIG. 2 is a block diagram showing a configuration example of a combination optimization calculation system 10 that controls a parameter of the quantum circuit according to the FALQON algorithm described above.

The combination optimization calculation system 10 includes a quantum computer 20 according to a quantum gate method and a classical computer. The quantum computer 20 and the classical computer can transmit and receive information through a predetermined communication network, for example. Examples of the communication network include the Internet, a cellular network, a local area network (LAN), and a dedicated line.

The quantum computer 20 executes a quantum calculation by the quantum circuit having a parameter representing a phase rotation amount, and includes a quantum circuit device 21 and a measurement device 22.

As shown in FIG. 1, the quantum circuit device 21 includes at least one quantum circuit.

The measurement device 22 measures (observes) the output (that is, the quantum state) from the quantum circuit device 21.

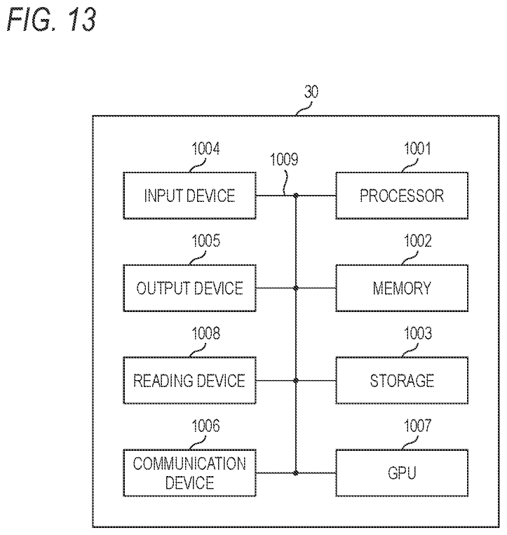

The classical computer 30 implements the function of a feedback amount calculation processor 31. As shown in FIG. 13, the classical computer 30 includes at least a processor 1001 and a memory 1002, and this function may be implemented by the processor 1001 reading and executing a computer program stored in the memory 1002.

The feedback amount calculation processor 31 calculates the feedback amount β based on the quantum state measured by the measurement device 22. Then, the feedback amount calculation processor 31 newly adds a quantum circuit in which the calculated feedback amount β is used as a parameter representing the phase rotation amount to the quantum circuit device 21. Accordingly, the number of stages of the quantum circuit in FIG. 1 is increased by one.

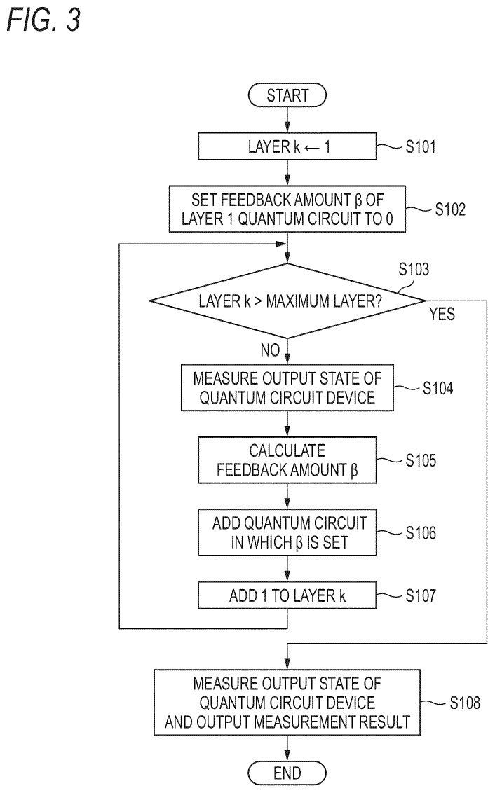

FIG. 3 is a flowchart showing an operation example of the combination optimization calculation system 10 that controls the parameter of the quantum circuit according to the FALQON algorithm described above.

The feedback amount calculation processor 31 sets a layer k to 1 (S101). Note that k represents a layer index. Here, k=t/Δt. In other words, t=kΔt. The layer k corresponds to the k-th stage quantum circuit in FIG. 1.

The feedback amount calculation processor 31 sets the feedback amount β₁ of the layer 1 quantum circuit to 0 (S102).

The feedback amount calculation processor 31 determines whether the layer k is larger than a predetermined maximum layer (S103).

When the layer k is the maximum layer or less (S103: NO), the feedback amount calculation processor 31 advances the processing to S104.

The measurement device 22 measures the output state from the quantum circuit device 21 (S104).

The feedback amount calculation processor 31 calculates the feedback amount β based on the measurement result of step S104 (S105).

The feedback amount calculation processor 31 adds, to the quantum circuit device 21, the quantum circuit (that is, the (k+1)-th stage quantum circuit) in which the feedback amount β calculated in step S105 is set (S106).

The feedback amount calculation processor 31 adds 1 to the layer k (S107), and returns the processing to step S103.

In the determination in step S103, when the layer k is larger than the predetermined maximum layer (S103: YES), the measurement device 22 measures the output state from the quantum circuit device 21 and outputs the measurement result (S108). The classical computer 30 may display the output measurement result as a graph or the like. Then, this processing ends.

According to the above processing, as shown in FIG. 1, the quantum circuit device 21 of the quantum computer 20 includes the quantum circuits of the layers 1 to k in which the feedback amounts β₁ to βₖ are respectively set. Further, the measurement device 22 can measure the output state from the quantum circuit device 21 implemented as described above.

### <Problem of FALQON>

In order to verify what kind of problem is caused when FALQON is applied to an actual problem, the applicant carried out an evaluation when the type or scale of the problem was changed.

First, regarding the MaxCut problem, which seeks a division method that maximizes the number of sides between groups when dividing the vertices of a graph into two groups, the expected solution was obtained.

Next, evaluation was executed on the traveling salesman problem of searching for the shortest route when one salesman visits a plurality of cities.

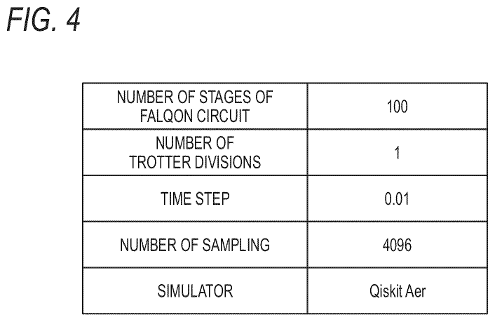

FIG. 4 shows a simulation condition when evaluating the traveling salesman problem.

In the case of the traveling salesman problem, an optimal solution was obtained for the problem size of three cities, but when the problem size was increased to four cities, it became difficult to obtain an executable solution.

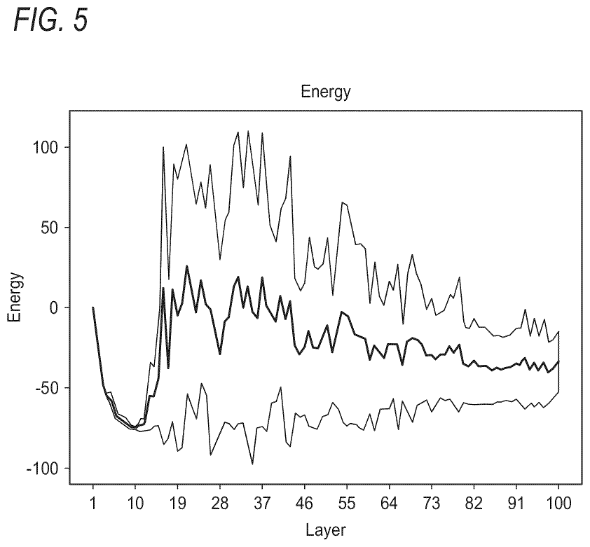

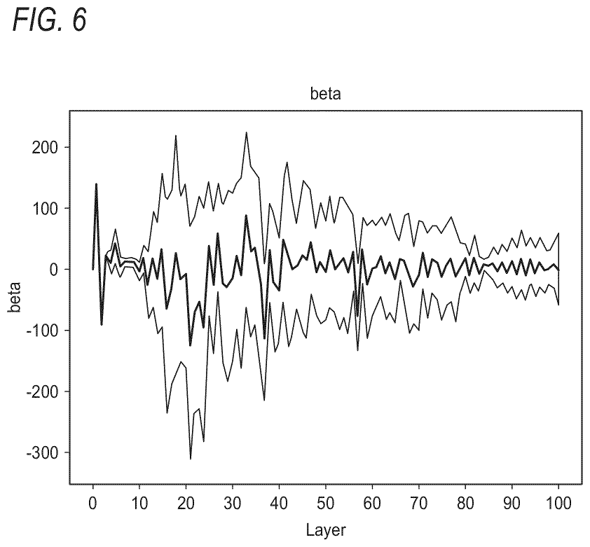

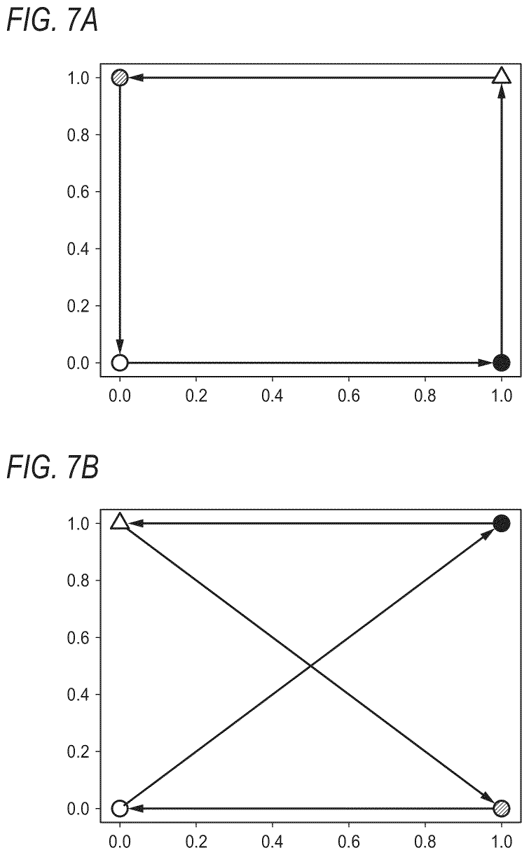

FIG. 5 is a graph showing a result of an expected energy value in each stage of the quantum circuit when solving the traveling salesman problem in four cities. FIG. 6 is a graph showing a result of the feedback amount β in each stage of the quantum circuit when solving the traveling salesman problem in four cities. FIGS. 7A and 7B are diagrams showing an executable solution of the traveling salesman problem in four cities.

In FIGS. 5 and 6, the solid line indicates the average value of 10 evaluations, and the range between the dotted lines indicates the standard deviation of data. From this result, it can be seen that both the expected energy value and the feedback amount have not converged. The probability that the solution having the maximum observation frequency becomes the executable solution as shown in FIGS. 7A and 7B was approximately 7%, and in the remaining 93%, the unexecutable solution including the result of not visiting any city was observed at the maximum frequency.

Based on the above, the applicant confirmed that FALQON cannot operate as expected depending on the type or scale of the problem to be solved. That is, FALQON, which is an algorithm for solving a combination optimization problem in a quantum computer according to a quantum gate method, may not operate as expected depending on the type or scale of the problem to be solved.

### <Method for Solving Problem of FALQON>

The time development of FALQON shown in the above (Formula 1) is the same as the quantum annealing method. Therefore, by applying the convergence condition for the weight of the quantum fluctuation term in the quantum annealing method to FALQON, the result of FALQON can also be expected to converge to the ground state of the target Hamiltonian.

In the quantum annealing method, the sufficient condition that the state of temporal change converges to the ground state of the target Hamiltonian is that a certain positive number t₀ is present, and that a weight Γ(t) of the quantum fluctuation term is given by the following (Formula 9) in t>t₀. A weight T of the quantum fluctuation term may be read as a gain function Γ.

$$Γ ( t ) = {a ( δ t + c )}^{- \frac{1}{2 N - 1}} \qquad ( Formula 9 )$$

Here, N is the number of quantum bits, a and c are constants, and δ is a fairly small amount satisfying δ<<1.

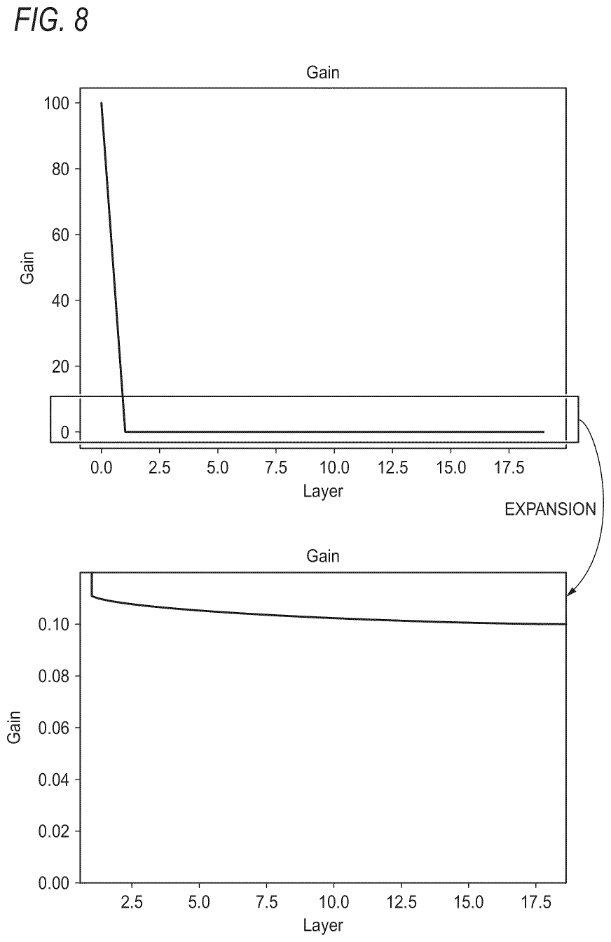

FIG. 8 is a graph showing an example of the weight Γ(t) of the quantum fluctuation term according to the present embodiment. In FIG. 8, the lower graph is an enlarged view of a portion surrounded by a dotted line in the upper graph. As shown in FIG. 8, the weight Γ(t) of the quantum fluctuation term has a positive value such that the magnitude of the weight Γ(t) approaches zero as the quantum circuit is added, that is, as the number of layers increases.

Since the feedback amount β(t) in FALQON only needs to change over time as in (Formula 9), it is considered that the gain of β(t) is controlled such that the envelope of β(t) is proportional to (Formula 9). More specifically, the feedback amount β(t) calculated in (Formula 5) is replaced with the following (Formula 10).

$$β ( t ) = - A ( t ) Γ ( t ) \qquad ( Formula 10 )$$

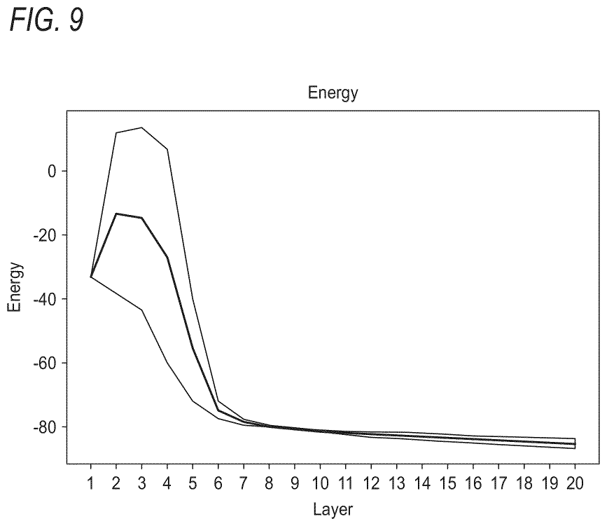

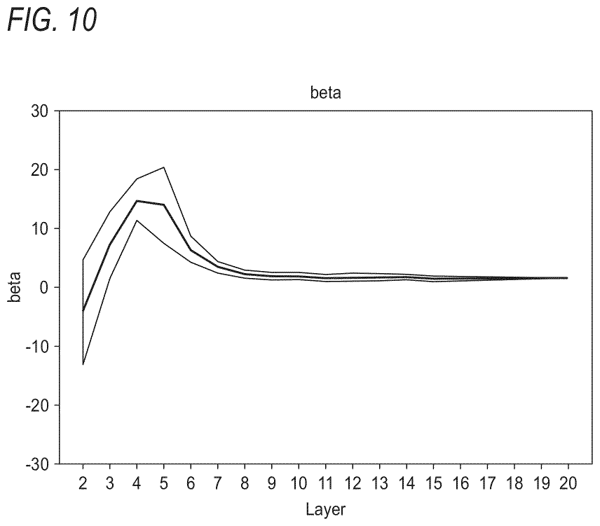

When β(t) is calculated using (Formula 10), the results of the expected energy value and feedback amount when solving the traveling salesman problem in four cities are shown in FIGS. 9 and 10.

FIG. 9 is a graph showing the result of the expected energy value in each stage of the quantum circuit when solving the traveling salesman problem in four cities using the weight of the quantum fluctuation term according to the present embodiment. FIG. 10 is a graph showing the result of the feedback amount β in each stage of the quantum circuit when solving the traveling salesman problem in four cities using the weight of the quantum fluctuation term according to the present embodiment. In FIGS. 9 and 10, as in FIGS. 5 and 6, the solid line indicates the average value of 10 evaluations, and the range between the dotted lines indicates the standard deviation of data.

Looking at the results shown in FIGS. 9 and 10, it can be confirmed that both converge by adding the control of the weight of the quantum fluctuation term. Since the average of the expected energy values monotonically decreases and the width of the standard deviation of the energy is reduced by increasing the number of stages of the quantum circuit, the observed state gradually approaches a single low energy state. Therefore, the low-energy state that minimizes the cost function is observed more frequently. Actually, the probability that the solution having the maximum observation frequency becomes the executable solution is improved from 7% to 100% by adding the control of the weight of the quantum fluctuation term to the feedback amount.

The feedback gain control method in which the convergence condition for the weight of the quantum fluctuation term in the quantum annealing method is applied to FALQON has been disclosed. Then, the applicant confirmed the effectiveness by simulation.

The method for calculating the weight (the gain function) Γ of the quantum fluctuation term is not limited to Formula 9 described above. As the weight (the gain function) Γ of the quantum fluctuation term, another function having a positive value such that the magnitude of the function approaches zero may be used as the quantum circuit is added. For example, the weight (the gain function) Γ of the quantum fluctuation term may be calculated according to the following (Formula 11). In Formula 11, L represents the total number of layers.

$$Γ ( k ) = \frac{1 + cos ( π k / L )}{2} \qquad ( Formula 11 )$$

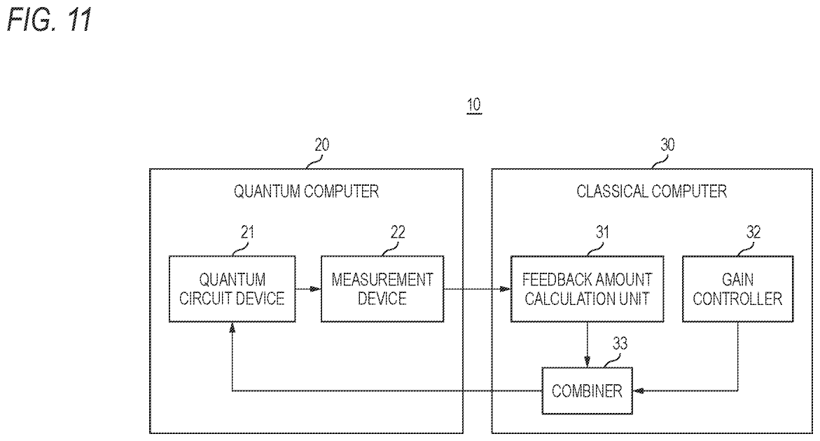

FIG. 11 is a block diagram showing a configuration example of the combination optimization calculation system 10 according to the present embodiment to which the feedback gain control method described above is applied.

Similarly to the combination optimization calculation system 10 shown in FIG. 2, the combination optimization calculation system 10 according to the present embodiment includes the quantum computer 20 according to a quantum gate method and the classical computer 30.

Since the configuration of the quantum computer 20 is the same as that shown in FIG. 2, the description thereof is omitted here.

The classical computer 30 implements functions of the feedback amount calculation processor 31, a gain controller 32, and a combiner 33. As shown in FIG. 13, the classical computer 30 includes at least the processor 1001 and the memory 1002, and functions thereof may be implemented by the processor 1001 reading and executing a computer program stored in the memory 1002.

Similarly to FIG. 2, the feedback amount calculation processor 31 calculates the feedback amount based on the quantum state measured (observed) by the measurement device 22. That is, the feedback amount calculation processor 31 calculates “−A(t)” in the above Formula 10.

The gain controller 32 calculates the weight Γ(t) of the quantum fluctuation term in the above (Formula 9) and (Formula 10).

The combiner 33 multiplies “−A(t)” output from the feedback amount calculation processor 31 by Γ(t) output from the gain controller 32 to obtain the feedback amount β(t) as shown in (Formula 10). Similarly to FIG. 2, the combiner 33 adds a quantum circuit to the quantum circuit device 21 using the feedback amount β(t).

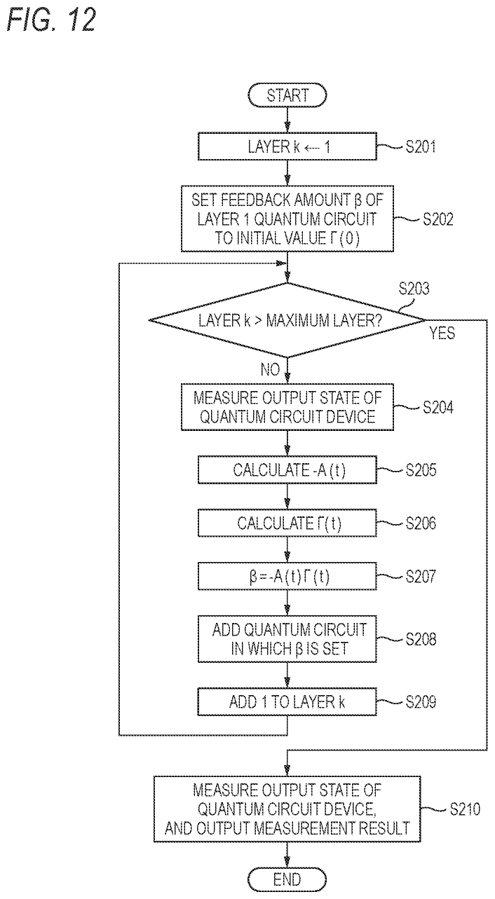

FIG. 12 is a flowchart showing an operation example of the combination optimization calculation system 10 that controls the parameter of the quantum circuit by the classical computer 30 according to the present embodiment.

The feedback amount calculation processor 31 sets the layer k to 1 (S201). Note that k represents a layer index. Here, k=t/Δt. In other words, t=kΔt. The layer k corresponds to the k-th stage quantum circuit in FIG. 1.

The combiner 33 sets the feedback amount β₁ of the quantum circuit of the layer 1 to an initial value Γ(0) (S202). That is, the feedback amount calculation processor 31 outputs 1, the gain controller 32 outputs Γ(0), and the combiner 33 sets β(0)=Γ(0) in the first stage quantum circuit.

The feedback amount calculation processor 31 determines whether the layer k is larger than a predetermined maximum layer (S203).

When the layer k is the maximum layer or less (S203: NO), the feedback amount calculation processor 31 advances the processing to S204.

The measurement device 22 measures the output state from the quantum circuit device 21 (S204).

The feedback amount calculation processor 31 calculates “−A(t)” based on the measurement result of step S204 (S205).

The gain controller 32 calculates Γ(t) (S206).

The combiner 33 multiplies “−A(t)” calculated by the feedback amount calculation processor 31 in step S205 by Γ(t) calculated by a gain processor in step S206 to calculate the feedback amount β(t)=−A(t)Γ(t) (S207).

The combiner 33 adds, to the quantum circuit device 21, the quantum circuit (that is, the quantum circuit of the layer (k+1)) in which the feedback amount β(t) calculated in step 207 is set (S208).

The feedback amount calculation processor 31 adds 1 to the layer k (S209), and returns the processing to S203.

In the determination in step S203, when the layer k is larger than the predetermined maximum layer (S203: YES), the measurement device 22 measures the output state from the quantum circuit device 21 and outputs the measurement result (S210). The classical computer 30 may display the output measurement result as a graph or the like on an output device 1005 (see FIG. 13). Then, this processing ends.

According to the above processing, as shown in FIG. 1, the quantum circuit device 21 of the quantum computer 20 includes the quantum circuits of the layers 1 to k in which the feedback amounts β₁ to βₖ calculated using the weight Γ(t) of the quantum fluctuation term are respectively set. Further, the measurement device 22 can measure the output state from the quantum circuit device 21 implemented as described above. The measurement result can converge, for example, as shown in FIGS. 9 and 10, compared to FIGS. 5 and 6, in which the measurement result did not converge using FALQON in the related art. Therefore, according to the combination optimization calculation system 10 in the present embodiment shown in FIGS. 11 and 12, even for the problem that an executable solution cannot be obtained using FALQON, an executable solution may sometimes be obtained.

Although the traveling salesman problem has been described above as an example of the combination optimization problem, the present embodiment is not limited to the traveling salesman problem. For example, the present embodiment is applicable to various combination optimization problems such as optimization of a package delivery plan, optimization of a personnel shift plan, and optimization of an AGV movement route in a factory.

### <Configuration of Classical Computer>

FIG. 13 is a block diagram showing a hardware configuration example of the classical computer 30 according to the present disclosure.

The classical computer 30 includes the processor 1001, the memory 1002, a storage 1003, an input device 1004, the output device 1005, a communication device 1006, a graphics processing unit (GPU) 1007, a reading device 1008, and a bus 1009.

The devices 1001 to 1008 are connected to the bus 1009 and can bidirectionally transmit and receive data via the bus 1009.

The processor 1001 is a device that executes a computer program stored in the memory 1002 to implement the functions described above. Examples of the processor 1001 include a central processing unit (CPU), a micro processing unit (MPU), a controller, a large scale integration (LSI), an application specific integrated circuit (ASIC), a programmable logic device (PLD), and a field-programmable gate array (FPGA).

The memory 1002 is a device that stores a computer program and data handled by the classical computer 30. The memory 1002 may include a read-only memory (ROM) and a random access memory (RAM). Examples of the ROM include an electrically erasable programmable read-only memory (EEPROM) and a flash memory. Examples of the RAM include a dynamic random access memory (DRAM) and a flash memory.

The storage 1003 is a device that is implemented by a nonvolatile storage medium, and that stores a computer program and data handled by the computer 1000. Examples of the storage 1003 include a hard disk drive (HDD), a solid state drive (SSD), and a flash memory.

The input device 1004 is a device that receives data to be input to the processor 1001. Examples of the input device 1004 include a keyboard, a mouse, a touch pad, and a microphone.

The output device 1005 is a device that outputs data generated by the processor 1001. Examples of the output device 1005 include a display and a speaker.

The communication device 1006 is a device that transmits and receives data to and from the quantum computer 20 via a communication network. The communication device 1006 may include a transmitter that transmits data and a receiver that receives data. The communication device 1006 may support either wired communication or wireless communication. Examples of the wired communication include Ethernet (registered trademark). Examples of the wireless communication include Wi-Fi (registered trademark), Bluetooth, long term evolution (LTE), 4G, and 5G.

The GPU 1007 is a device that processes image depiction at high speed. The GPU 1007 may be used for processing (for example, deep learning) of artificial intelligence (AI).

The reading device 1008 is a device that reads data from a recording medium such as a digital versatile disk read only memory (DVD-ROM) or a universal serial bus (USB) memory.

The function of the classical computer 30 may be implemented as an LSI, which is an integrated circuit. These functions may be individually integrated into one chip, or may include some or all of these functions into one chip. Here, the function is implemented as an LSI. Alternatively, the function may also be called an IC, a system LSI, a super LSI, or an ultra LSI depending on the degree of integration. Further, if an integrated circuit technology that replaces the LSI emerges due to an advancement in semiconductor technology or another derived technology, the functions may naturally be integrated using that technology.

### Summary of Present Disclosure

The content of the present disclosure can be expressed as follows.

### <Expression 1>

A combination optimization calculation method for calculating combination optimization using a quantum computer 20 configured to execute quantum calculation by a quantum circuit having a parameter representing a phase rotation amount, and a classical computer 30 configured to calculate a feedback amount β based on an output of the quantum computer 20 and to newly add, to the quantum computer 20, the quantum circuit having the calculated feedback amount β as the parameter includes: multiplying, in the classical computer 30, the feedback amount β by a gain Γ having a positive value such that a magnitude of the gain Γ approaches zero as the quantum circuit is added.

### <Expression 2>

In the combination optimization calculation method according to Expression 1, the feedback amount β may be a feedback amount in feedback-based algorithm for quantum optimization (FALQON) algorithm.

### <Expression 3>

In the combination optimization calculation method according to Expression 1 or 2, a convergence condition for a weight of a quantum fluctuation term in a quantum annealing may be used as a gain function Γ for calculating the gain.

### <Expression 4>

In the combination optimization calculation method according to Expression 3, the gain function Γ may be as follows.

### [Formula 12]

$$Γ ( t ) = {a ( δ t + c )}^{- \frac{1}{2 N - 1}}$$

Here, t may be a time variable, N may be the number of quantum bits, a and c may be constants, and δ may be a fairly small amount satisfying δ<<1.

According to the method described above, an executable solution may be obtained even for the problem that an executable solution cannot be obtained using FALQON.

### <Expression 5>

A combination optimization calculation system 10 includes: a quantum computer 20 configured to execute quantum calculation by a quantum circuit having a parameter representing a phase rotation amount; and a classical computer configured to calculate a feedback amount based on an output of the quantum computer 20 and to newly add, to the quantum computer, the quantum circuit having the calculated feedback amount as the parameter. The classical computer 30 multiplies the feedback amount by a gain having a positive value such that a magnitude of the gain approaches zero as the quantum circuit is added.

According to the configuration described above, an executable solution may be obtained even for the problem that an executable solution cannot be obtained using FALQON.

Although the embodiment has been described above with reference to the accompanying drawings, the present disclosure is not limited to such an embodiment. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, constituent elements in the embodiment described above may be freely combined without departing from the gist of the invention.

The present application is based on Japanese Patent Application No. 2021-150621 filed on Sep. 15, 2021, and the contents thereof are incorporated herein by reference.

### INDUSTRIAL APPLICABILITY

The technology according to the present disclosure is useful for a method, a device, or a system for solving the combination optimization problem by applying quantum mechanics.

### REFERENCE SIGNS LIST

10: combination optimization calculation system
20: quantum computer
21: quantum circuit device
22: measurement device
30: classical computer
31: feedback amount calculation processor
32: gain controller
33: combiner

What is claimed is:

1. A combination optimization calculation method for calculating combination optimization using a quantum computer and a classical computer,
the quantum computer that executes quantum calculation by a quantum circuit having a parameter representing a phase rotation amount, and
the classical computer that calculates a feedback amount based on an output of the quantum computer and newly adds, to the quantum computer, the quantum circuit having the calculated feedback amount as the parameter,
the combination optimization calculation method comprising:
multiplying, in the classical computer, the feedback amount by a gain having a positive value such that a magnitude of the gain approaches zero as the quantum circuit is added.

2. The combination optimization calculation method according to claim 1,
wherein the feedback amount is a feedback amount in feedback-based algorithm for quantum optimization (FALQON) algorithm.

3. The combination optimization calculation method according to claim 1,
wherein a convergence condition for a weight of a quantum fluctuation term in a quantum annealing is used as a gain function for calculating the gain.

4. The combination optimization calculation method according to claim 3,
wherein the gain function is the following Formula 1, and
$$Γ ( t ) = {a ( δ t + c )}^{- \frac{1}{2 N - 1}}$$
where t is a time variable, N is the number of quantum bits, a and c are constants, and δ is a fairly small amount satisfying δ<<1.

5. A combination optimization calculation system comprising:
a quantum computer that executes quantum calculation by a quantum circuit having a parameter representing a phase rotation amount; and
a classical computer that calculates a feedback amount based on an output of the quantum computer and newly adds, to the quantum computer, the quantum circuit having the calculated feedback amount as the parameter,
wherein the classical computer multiplies the feedback amount by a gain having a positive value such that a magnitude of the gain approaches zero as the quantum circuit is added.
